(19) United States
(12) Patent Application Publication
(10) Pub. No.: US 2019/0346960 A1
(43) Pub. Date: Nov. 14, 2019

(54) TOUCH DISPLAY DEVICE

(71) Applicant: Chunghwa Picture Tubes, LTD., Taoyuan City (TW)

(72) Inventors: Zhen-Wei Liang, Taoyuan City (TW); Chung-I Hu, Kaohsiung City (TW)

(73) Assignee: Chunghwa Picture Tubes, LTD., Taoyuan City (TW)

(21) Appl. No.: 16/053,788

(22) Filed: Aug. 2, 2018

(30) Foreign Application Priority Data
May 8, 2018 (CN) 201810430338.9

(51) Int. Cl. G06F 3/041; G09G 3/36

(52) U.S. Cl. CPC G06F 3/0416; G09G 2300/043; G09G 3/3677; G06F 3/0412

(57) ABSTRACT

A touch display device includes a touch display panel, a gate driver, a touch sensing processor and a common compensation voltage processing circuit. The touch display panel includes gate lines, pixels, common detection electrodes and common compensation electrodes. The pixels, arranged in an array, couples to the gate lines and the data lines. The common detection electrodes, arranged in an array, individually overlap with a part of the pixels. The common compensation electrodes respectively dispose between every two adjacent rows of the common detection electrodes. The gate driver couples to the gate lines to provide sequentially enabled gate signals thereto during a display period. The touch sensing processor couples to the common detection electrodes, and sets voltage levels of the common detection electrodes to a common voltage during the display period, and scans the common detection electrodes to determine whether the touch display panel is touched during a touch period.

### CROSS-REFERENCE TO RELATED APPLICATION

This application claims the priority benefit of China application serial no. 201810430338.9, filed on May 8, 2018. The entirety of the above-mentioned patent application is hereby incorporated by reference herein and made a part of this specification.

### BACKGROUND OF THE INVENTION

### Field of the Invention

The invention relates to a touch display device.

### Description of Related Art

In today's world, along with rapid development of science and technology, a liquid crystal display (LCD) is also integrated with a plurality of functions including a touch sensing technique. However, along with more and more integrated functions, the quality of display images also faces some extended problems. In a structure of an embedded touch display device, a touch sensor thereof and a common electrode (Vcom) of the LCD share a same layer of transparent conductive electrode (e.g. ITO). Therefore, due to a coupling effect of a gate signal line, voltage inaccuracy of the common electrode (Vcom) is probably occurred, which may influence the display quality.

### SUMMARY OF THE INVENTION

The invention is directed to a touch display device, which is adapted to mitigate a stripe phenomenon of a touch display panel. The touch display device includes a touch display panel, a gate driver, a touch sensing processor and a common compensation voltage processing circuit. The touch display panel includes a plurality of gate lines, a plurality of data lines, a plurality of pixels, a plurality of common detection electrodes and a plurality of common compensation electrodes. The pixels are arranged in an array, and are individually coupled to the corresponding gate lines and the corresponding data lines. The common detection electrodes are arranged in an array, and each of the common detection electrodes is overlapped with a part of the pixels. The common compensation electrodes are respectively disposed between every two adjacent rows of the common detection electrodes. The gate driver is coupled to the gate lines to provide a plurality of sequentially enabled gate signals to the gate lines during a display period. The touch sensing processor is coupled to the common detection electrodes, and sets voltage levels of the common detection electrodes to a common voltage during the display period, and scans the common detection electrodes to determine whether the touch display panel is touched during a touch period. The common compensation voltage processing circuit is coupled to the common compensation electrodes, and provides at least one common compensation voltage to the common compensation electrodes during the display period.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system schematic diagram of a touch display device according to an embodiment of the invention.

FIG. 2 is a circuit schematic diagram of a common compensation voltage processing circuit according to an embodiment of the invention.

FIG. 3 is a schematic diagram of a configuration of a touch display panel according to a first embodiment of the invention.

FIG. 4 is a schematic diagram of a configuration of a touch display panel according to a second embodiment of the invention.

FIG. 5 is a schematic diagram of a configuration of a touch display panel according to a third embodiment of the invention.

FIG. 6 is a schematic diagram of a configuration of a touch display panel and a common compensation voltage processing circuit according to a fourth embodiment of the invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

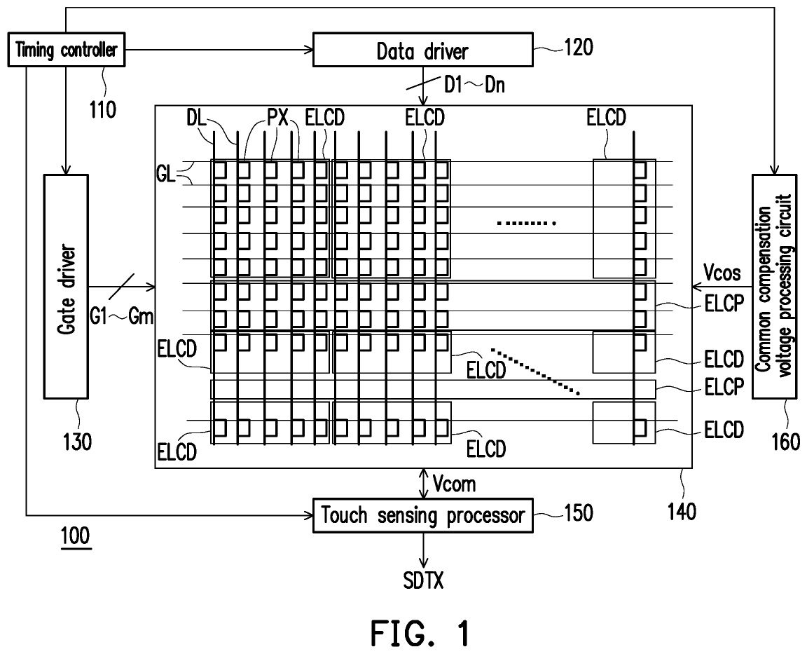

FIG. 1 is a system schematic diagram of a touch display device according to an embodiment of the invention. Referring to FIG. 1, in the embodiment, the touch display device 100 includes a timing controller 110, a data driver 120, a gate driver 130, a touch display panel 140, a touch sensing processor 150 and a common compensation voltage processing circuit 160. The data driver 120 is coupled between the timing controller 110 and the touch display panel 140, and provides a plurality of data voltages D1-Dn to the touch display panel 140 under control of the timing controller 110 during a display period, where n is a positive integer. The gate driver 130 is coupled between the timing controller 110 and the touch display panel 140, and provides a plurality of sequentially enabled gate signals G1-Gm to the touch display panel 140 under control of the timing controller 110 during the display period, where m is a positive integer.

The touch display panel 140 includes a plurality of data lines DL, a plurality of gate lines GL, a plurality of pixels PX, a plurality of common detection electrodes ELCD, and a plurality of common compensation electrodes ELCP. The data lines DL are coupled to the data driver 120 to receive the corresponding data voltages (for example, D1-Dn). The gate lines GL are coupled to the gate driver 130 to receive the corresponding gate signals (for example, G1-Gm). The pixels PX are arranged in an array, and are individually coupled to the corresponding data lines DL and the corresponding gate lines GL, so as to receive the corresponding data voltages (for example, D1-Dn) according to the corresponding gate signals (for example, G1-Gm) to determine grayscale values displayed by the individual pixels PX.

The common detection electrodes ELCD are arranged in an array, and each of the common detection electrodes ELCD is overlapped with a part of the pixels PX, for example, the pixels PX in an array of 5×5, though the invention is not limited thereto. Moreover, the common compensation electrodes ELCP are respectively disposed between every two adjacent rows of the common detection electrodes ELCD, i.e. the common detection electrodes ELCD and the common compensation electrodes ELCP are not overlapped for position on the touch display panel 140. In other words, the gate lines GL overlapped with the common detection electrodes ELCD are different to the gate lines GL overlapped with the common compensation electrodes ELCP, where the number of the gate lines GL overlapped with the common detection electrodes ELCD and the number of the gate lines GL overlapped with the common compensation electrodes ELCP may be determined according to an actual circuit design, which are not limited by the invention.

The touch sensing processor 150 is coupled to the timing controller 110 and all of the common detection electrodes ELCD, and sets the common detection electrodes ELCD or detects the common detection electrodes ELCD under control of the timing controller 110. In other words, during the display period, and the touch sensing processor 150 is controlled by the timing controller 110 to set voltage levels of all of the common detection electrodes ELCD to a common voltage Vcom, and during a touch period, the touch sensing processor 150 is controlled by the timing controller 110 to scan all of the common detection electrodes ELCD to determine whether the touch display panel 140 is touched, and correspondingly provides a touch sensing signal SDTX, where the display period and the touch period are not overlapped with each other in timing.

The common compensation voltage processing circuit 160 is coupled to the timing controller 110 and all of the common compensation electrodes ELCP. During the display period, the common compensation voltage processing circuit 160 is controlled by the timing controller 110 to provide at least one common compensation voltage Vcos to all of the common compensation electrodes ELCP to adjust the grayscale values displayed by the overlapped pixels PX, and during the touch period, the common compensation voltage processing circuit 160 is controlled by the timing controller 110 to float the common compensation electrodes ELCP or set all of the common compensation electrodes ELCP to the common voltage Vcom, which is determined according to an actual circuit design and is not limited by the invention.

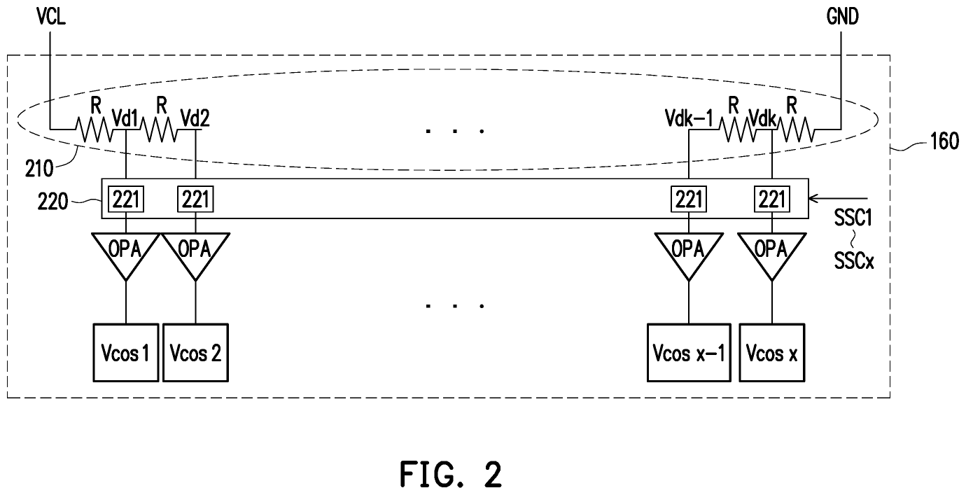

FIG. 2 is a circuit schematic diagram of a common compensation voltage processing circuit according to an embodiment of the invention. Referring to FIG. 1 and FIG. 2, in the embodiment, the common compensation voltage processing circuit 160 includes a resistor string 210, a switch circuit 220 and at least one direct current (DC) amplifier OPA. The resistor string 210 receives a ground voltage GND and a control voltage VCL to provide a plurality of divided voltages Vd1-Vdk, where k is a positive integer greater than 2, and the ground voltage GND and the control voltage VCL may be provided by a power circuit, though the invention is not limited thereto. Further, the resistor string 210 includes a plurality of resistors R connected in series between the ground voltage GND and the control voltage VCL, and a connection between the resistors R provides one of the divided voltages Vd1-Vdk.

The switch circuit 220 receives switch control signals SSC1-SSCx and the divided voltages Vd1-Vdk to provide at least one of the divided voltages Vd1-Vdk. The DC amplifiers OPA individually receive one of the divided voltages Vd1-Vdk provided by the switch circuit 220 to provide corresponding common compensation voltages Vcos 1-Vcos x,where k and x are positive integers greater than 1. Further, under control of the corresponding switch control signal SSC1 (for example, a digital signal of 8 bits), the common compensation voltage Vcos 1 may be one of the divided voltages Vd1-Vdk; under control of the corresponding switch control signal SSC2 (for example, a digital signal of 8 bits), the common compensation voltage Vcos2 may also be one of the divided voltages Vd1-Vdk, and the others are deduced by analogy.

In the embodiment, the switch circuit 220, for example, includes at least one selection circuit 221, and the selection circuit 221 may be a multiplexer or a similar element, which is not limited by the invention. Moreover, in the embodiment, the number of the selection circuits 221 and the number of the DC amplifiers OPA are the same to the number of the common compensation voltages Vcos 1-Vcos x. For example, when the selection circuits 221 receive the divided voltages Vd1-Vdk and the switch control signal SSC1, the DC amplifiers OPA coupled to the selection circuits 221 provide the common compensation voltage Vcos 1; when the selection circuits 221 receive the divided voltages Vd1-Vdk and the switch control signal SSC2, the DC amplifiers OPA coupled to the selection circuits 221 provide the common compensation voltage Vcos2, and the others are deduced by analogy, and are not repeated.

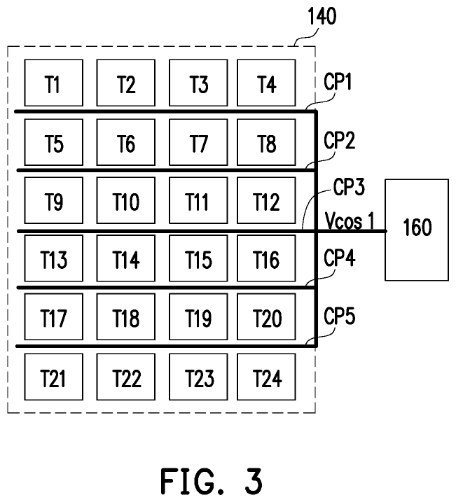

FIG. 3 is a schematic diagram of a configuration of a touch display panel according to a first embodiment of the invention. Referring to FIG. 1 and FIG. 3, in the embodiment, for simplicity's sake, only a plurality of the common detection electrodes ELCD (represented by electrodes T1-T24) and a plurality of the common compensation electrodes ELCP (represented by electrodes CP1-CP5) are shown in FIG. 3, where the same or similar components are denoted by the same or similar referential numbers.

In the embodiment, one common compensation electrode (for example, one of the electrodes CP1-CP5 is disposed between every two adjacent rows of the common detection electrodes ELCD (for example, the electrodes T1-T24). Moreover, the electrodes CP1-CP5 are commonly coupled to one terminal of the common compensation voltage processing circuit 160 to commonly receive the same common compensation voltage Vos 1, i.e. the common compensation voltage processing circuit 160 provides the single common compensation voltage Vos 1 to all of the common compensation electrodes (for example, the electrodes CP1-CP5). In this way, a stripe phenomenon occurred at a boundary between two common detection electrodes ELCD due to the influence of a coupling effect of the gate signals G1-Gm on the common detection electrodes ELCD is mitigated.

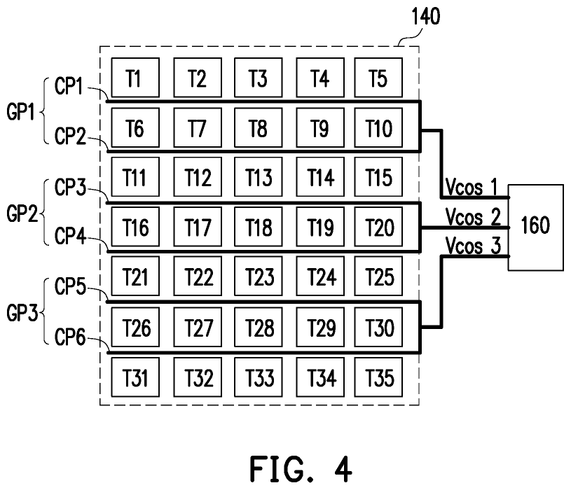

FIG. 4 is a schematic diagram of a configuration of a touch display panel according to a second embodiment of the invention. Referring to FIG. 1 and FIG. 4, in the embodiment, for simplicity's sake, only a plurality of the common detection electrodes ELCD (represented by electrodes T1-T35) and a plurality of the common compensation electrodes ELCP (represented by electrodes CP1-CP6) are shown in FIG. 4, where the same or similar components are denoted by the same or similar referential numbers.

In the embodiment, the common compensation electrodes (for example, the electrodes CP1-CP6) are divided into a plurality of electrode sets (for example, GP1-GP3), i.e. two common compensation electrodes (for example, the electrodes CP1-CP6) construct one electrode set (for example, GP1-GP3), and the common compensation voltage processing circuit 160 provides the common compensation voltage (for example, Vcos 1-Vcos3) to one of the electrode sets GP1-GP3. For example, the common compensation voltage processing circuit 160 may provide the common compensation voltage Vcos 1 to the electrode set GP1, the common compensation voltage processing circuit 160 may provide the common compensation voltage Vcos 2 to the electrode set GP2, and the common compensation voltage processing circuit 160 may provide the common compensation voltage Vcos 3 to the electrode set GP3. In this way, the common compensation voltage processing circuit 160 may mitigate the problem of providing different common compensation voltages (for example, Vcos 1-Vcos 3) due to different coupling degrees of the common detection electrodes ELCD, and may effectively mitigate the stripe phenomenon caused by different coupling degrees through dividing and adjusting.

In the embodiment, each of the electrode sets GP1-GP3 includes two common compensation electrodes (for example, the electrodes CP1-CP6), though in other embodiments, each of the electrode sets GP1-GP3 includes three or more common compensation electrodes (for example, the electrodes CP1-CP6), which is not limited by the invention.

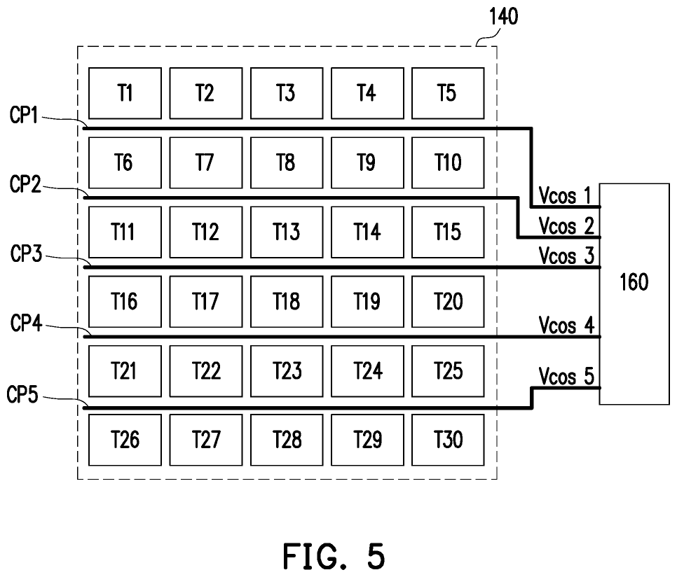

FIG. 5 is a schematic diagram of a configuration of a touch display panel according to a third embodiment of the invention. Referring to FIG. 1 and FIG. 5, in the embodiment, for simplicity's sake, only a plurality of the common detection electrodes ELCD (represented by electrodes T1-T30) and a plurality of the common compensation electrodes ELCP (represented by electrodes CP1-CP5) are shown in FIG. 5, where the same or similar components are denoted by the same or similar referential numbers.

In the embodiment, the common compensation voltage processing circuit 160 provides the individually set common compensation voltages (for example, Vcos 1-Vcos5) to the common compensation electrodes (for example, the electrodes CP1-CP5), where the common compensation voltages (for example, Vcos 1-Vcos5) are in one-to-one correspondence with the common compensation electrodes (for example, the electrodes CP1-CP5). For example, the common compensation voltage processing circuit 160 may provide the common compensation voltage Vcos 1 to the electrode CP1, the common compensation voltage processing circuit 160 may provide the common compensation voltage Vcos 2 to the electrode CP2, and the others may be deduced by analogy. In this way, by providing the common compensation voltages to the individual common compensation electrodes, the common voltage between the common detection electrodes ELCD may be effectively adjusted to optimization, so as to mitigate the stripe phenomenon occurred in each row of the common detection electrodes ELCD to improve the overall display quality.

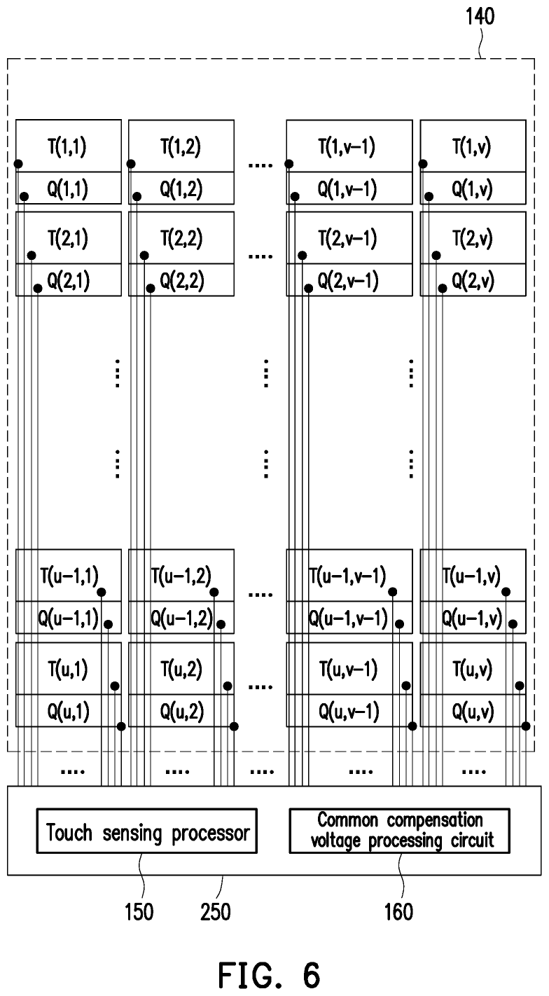

FIG. 6 is a schematic diagram of a configuration of a touch display panel and a common compensation voltage processing circuit according to a fourth embodiment of the invention. Referring to FIG. 1 and FIG. 6, in the embodiment, for simplicity's sake, only a plurality of the common detection electrodes ELCD (represented by electrodes T(1,1)-T(u,v)) and a plurality of the common compensation electrodes ELCP (represented by electrodes Q(1,1)-Q(u,v)) are shown in FIG. 6, and a sensing processing circuit 250 integrates the functions of the touch sensing processor 150 and the common compensation voltage processing circuit 160, where the same or similar components are denoted by the same or similar referential numbers, and u and v are positive integers.

In the embodiment, one common compensation electrode (for example, the electrodes Q(1,1)-Q(u,v)) is disposed between every two adjacent rows of the common detection electrodes (for example, the electrodes T(1,1)-T(u,v)), and between every two of the vertically adjacent common detection electrodes (for example, the electrodes T(1,1)-T(u,v)). In an embodiment of the invention, the common compensation voltage processing circuit 160 may provide a single common compensation voltage to all of the common compensation electrodes (for example, the electrodes Q(1,1)-Q(u,v)); or the common compensation electrodes (for example, the electrodes Q(1,1)-Q(u,v)) may be divided into a plurality of electrode sets (for example, a plurality of adjacent common compensation electrodes are divided into a same electrode set), and the common compensation voltage processing circuit 160 provides a plurality of common compensation voltages to the electrode sets, where the common compensation voltages are in one-to-one correspondence with the electrode sets, and each of the electrode sets includes at least two common compensation electrodes. Namely, at least two adjacent electrodes in the electrodes Q(1,1)-Q(u,v) construct one electrode set, where an adjacent direction may be vertical, horizontal or array arrangement; or the common compensation voltage processing circuit 160 provides the individually set common compensation voltages to a plurality of common compensation electrodes, where the common compensation voltages are in one-to-one correspondence with the common compensation electrodes.

In summary, in the touch display device of the embodiments of the invention, the common compensation electrodes are respectively disposed between every two adjacent rows of the common detection electrodes, and the common compensation voltages are provided to the common compensation electrodes. In this way, the stripe phenomenon of the touch display panel is mitigated.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch display device, comprising:
a touch display panel, comprising:
a plurality of gate lines;
a plurality of data lines;
a plurality of pixels, arranged in an array, and individually coupled to the corresponding gate line and the corresponding data line;
a plurality of common detection electrodes, arranged in an array, and each of the common detection electrodes being overlapped with a part of the pixels; and
a plurality of common compensation electrodes, respectively disposed between every two adjacent rows of the common detection electrodes;
a gate driver, coupled to the gate lines to provide a plurality of sequentially enabled gate signals to the gate lines during a display period;
a touch sensing processor, coupled to the common detection electrodes, and setting voltage levels of the common detection electrodes to a common voltage during the display period, and scanning the common detection electrodes to determine whether the touch display panel is touched during a touch period; and
a common compensation voltage processing circuit, coupled to the common compensation electrodes, and providing at least one common compensation voltage to the common compensation electrodes during the display period.

2. The touch display device as claimed in claim 1, wherein one of the common compensation electrodes is disposed between every two adjacent rows of the common detection electrodes.

3. The touch display device as claimed in claim 2, wherein the common compensation voltage processing circuit provides one common compensation voltage to the common compensation electrodes.

4. The touch display device as claimed in claim 2, wherein the common compensation electrodes are divided into a plurality of electrode sets, and the common compensation voltage processing circuit provides a plurality of common compensation voltages to the electrode sets, wherein each of the electrode sets comprises at least two of the common compensation electrodes.

5. The touch display device as claimed in claim 2, wherein the common compensation voltage processing circuit provides a plurality of individually set common compensation voltages to the common compensation electrodes, wherein the common compensation voltages are in one-to-one correspondence with the common compensation electrodes.

6. The touch display device as claimed in claim 1, wherein one of the common compensation electrodes is disposed between every two adjacent rows of the common detection electrodes, and between every two of the vertically adjacent common detection electrodes.

7. The touch display device as claimed in claim 6, wherein the common compensation voltage processing circuit provides a common compensation voltage to the common compensation electrodes.

8. The touch display device as claimed in claim 6, wherein the common compensation electrodes are divided into a plurality of electrode sets, and the common compensation voltage processing circuit provides a plurality of common compensation voltages to the electrode sets, wherein each of the electrode sets comprises at least two of the common compensation electrodes.

9. The touch display device as claimed in claim 6, wherein the common compensation voltage processing circuit provides a plurality of individually set common compensation voltages to the common compensation electrodes, wherein the common compensation voltages are in one-to-one correspondence with the common compensation electrodes.

10. The touch display device as claimed in claim 1, wherein the common compensation voltage processing circuit comprises:
a resistor string, receiving a ground voltage and a control voltage to provide a plurality of divided voltages;
a switch circuit, receiving at least one switch control signal and the divided voltages to provide at least one of the divided voltages; and
at least one direct current amplifier, individually receiving one of the divided voltages provided by the switch circuit to provide the corresponding common compensation voltage.
